(19) United States
(12) Patent Application Publication
(10) Pub. No.: US 2024/0406835 A1
(43) Pub. Date: Dec. 5, 2024

(54) ENERGY-AWARE ROUTING BASED ON REINFORCEMENT LEARNING

(71) Applicant: Telefonaktiebolaget LM Ericsson (publ), Stockholm (SE)

(72) Inventors: Athanasios KARAPANTELAKIS, Solna (SE); Konstantinos VANDIKAS, Solna (SE); Marin ORLIC, Bromma (SE); Maxim TESLENKO, Sollentuna (SE); Marios DAOUTIS, Bromma (SE); Alexandros NIKOU, Danderyd (SE); Aneta VULGARAKIS FELJAN, Stockholm (SE); Lackis ELEFTHERIADIS, Valbo (SE)

(21) Appl. No.: 18/698,168

(22) PCT Filed: Aug. 3, 2021
(86) PCT No.: PCT/SE2021/050769

§ 371 Date: Apr. 3, 2024

(51) Int. Cl. H04W 40/10; G06N 3/092; H04W 40/22; H04W 84/04

(52) U.S. Cl. CPC H04W 40/10; G06N 3/092; H04W 40/22; H04W 84/047

(57) ABSTRACT

There is provided a method for training a reinforcement learning system for optimising routing for a network including a plurality of Integrated Access and Backhaul (IAB) nodes connected to an IAB donor. The method includes acquiring observations characterising a current state of the plurality of IAB nodes, determining an action to be performed based on latest acquired observations, executing the action by initiating update of the routing information based on the determined action, acquiring observations characterising an updated state of the plurality of IAB nodes, determining a reward for the determined action, based on the updated state of the plurality of IAB nodes, storing an experience set, and training the reinforcement learning system to maximise reward with respect to an optimisation objective, using the one or more stored experience sets in the buffer.

### TECHNICAL FIELD

The present disclosure relates to the field of network routing, specifically methods, computer programs, and computer program products for training reinforcement learning systems for optimising routing for Integrated Access Backhaul (IAB) networks and managing routing for IAB networks.

### BACKGROUND

In 5G, higher frequencies (i.e. the Gigahertz spectrum, which is also known as millimetre wave (mmWave) frequencies, up to 52.6 GHZ) will serve the requirements of new application types such as ultra-reliable low latency communications (uRLLC) and enhanced mobile broadband (eMBB). There are however inherent problems associated with these high frequencies: shorter wavelengths have a smaller signal range and are more susceptible to inference and degradation. The effective range of 5G New Radio (NR) could be as little as 300 m, whereas in Long-term Evolution (LTE), signals can reach 16 km.

This network densification creates challenges for deployment of backhaul using existing solutions (e.g. fibre, microwave). Integrated Access and Backhaul (IAB) allows for multi-hop backhauling using the same frequencies employed for user equipment (UE) access for a distinct and dedicated frequency. With IAB, only a few Next Generation NodeBs (gNBs) need to be connected to traditional fibre infrastructure, while others wirelessly relay backhaul traffic through multiple hops at mmWave frequencies.

IAB has been studied in the scope of LTE networks, known as LTE-relaying, but has not been realised at scale in commercial networks as operators did not find a need for it. However, in 5G this is subject to change as denser networks justify the cost savings of IAB. 3GPP TS 38.874 v16.4.0 provides the details on the implementation of IAB: a fraction of gNBs that have fibre connection act as IAB donors; the remainder of the nodes without wired connection act as IAB nodes. Both types generate equivalent cell coverage and appear identical to the UE(s) in the area. In an IAB node, mobile termination (MT) function connects with an upstream IAB node or IAB donor, while a distributed unit (DU) function connects to UE access (Uu) and downstream MTs of other IAB nodes. A Backhaul Adaptation Protocol (BAP) is added to the stack that manages the routing between IAB nodes and IAB donors on top of the Radio Link Control (RLC) protocol.

IAB can function in both standalone (SA) and non-standalone (NSA) mode. NSA is a transitionary approach where New Radio (NR) node coexists with LTE radio access, while SA is standalone NR. When operating in NSA mode, only the NR Uu (i.e. the NR air interface) is used for backhauling. When an IAB node becomes active, it executes the IAB integration procedure—this is broken down into three phrases and is explained in 3GPP TS 38.401 v16.3.0. This is illustrated in FIG. 1A and FIG. 1B, which are respectively a diagram illustrating IAB integration in NR standalone mode from 3GPP TS 38.104 v16.3.0, and a diagram illustrating IAB integration in non-standalone NR/LTE (eNodeB/E-UTRAN) mode from 3GPP TS 38.104 v16.3.0.

### SUMMARY

One aspect of the present disclosure provides computer-implemented method for training a reinforcement learning system for optimising routing for a network including a plurality of Integrated Access and Backhaul (IAB) nodes connected to a IAB donor. The method comprises: acquiring observations characterising a current state of the plurality of IAB nodes, wherein the observations comprise: routing information for routing packets in the network, energy information indicative of an energy performance of each of the plurality of IAB nodes, and traffic information indicative of data traffic performance of each of the plurality of IAB nodes; and performing the following steps iteratively until a termination condition is met: determining an action to be performed from a predetermined set of actions using a selection policy and based on latest acquired observations, wherein the predetermined set of actions include adding an entry to the routing information and removing an entry to the routing information, wherein an entry is indicative of how packets are to be routed with respect to a IAB node; executing the action by initiating update of the routing information based on the determined action; acquiring observations characterising an updated state of the plurality of IAB nodes subsequent to execution of the action; determining a reward for the determined action, based on the updated state of the plurality of IAB nodes; storing an experience set including the determined action, the observations characterising the state of the plurality of IAB nodes prior to execution of the determined action, the observations characterising the state of the plurality of IAB nodes subsequent to execution of the determined action, and the determined reward; and training the reinforcement learning system to maximise reward with respect to an optimisation objective, using the one or more stored experience sets in the buffer.

Another aspect of the present disclosure provides for managing routing for a network including a plurality of Integrated Access and Backhaul (IAB) nodes connected to a IAB donor. The method comprises: training a reinforcement learning system as described herein, and using the trained reinforcement learning system to determine an action for a IAB node in the plurality of IAB nodes upon a condition trigger.

Another aspect of the present disclosure provides a computer program comprising instructions which, when executed by processing circuitry, cause the processing circuitry to perform the method as described herein.

Another aspect of the present disclosure provides a computer program product embodied on a non-transitory machine-readable medium, comprising instructions which are executable by processing circuitry to cause the processing circuitry to perform the method described herein.

Another aspect of the present disclosure provides an Integrated Access and Backhaul (IAB) node configured to perform the method described herein.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1A is a diagram illustrating IAB integration in NR standalone mode;

FIG. 1B is a diagram illustrating IAB integration in non-standalone NR/LTE (eNB/E-UTRAN) mode;

FIG. 2A illustrates an IAB network according to an embodiment of the present disclosure;

FIG. 2B illustrates the system of FIG. 2A converted into a reinforcement learning context;

FIG. 3 is diagram illustrating exemplary topology of IAB nodes and IAB donor, according to an embodiment of the present disclosure;

FIG. 4 is a sequence diagram illustrating an exemplary training process of NR integrated backhaul, according to an embodiment of the present disclosure;

FIG. 5 is a sequence diagram illustrating message flow in a reinforcement learning system during execution, according to an embodiment of the present disclosure;

FIG. 6 is a flowchart illustrating a method for training a reinforcement learning system for optimising routing for a network, according to an embodiment of the present disclosure; and

FIG. 7 is a flowchart illustrating a method for managing routing for a network, according to an embodiment of the present disclosure.

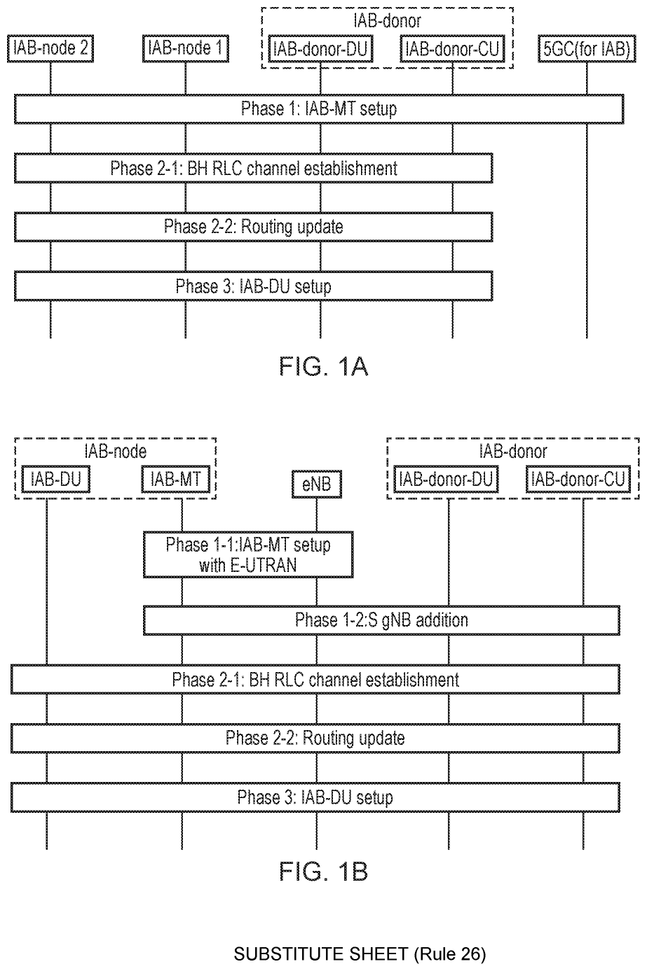

### DETAILED DESCRIPTION

The present disclosure focusses on the first phase of the IAB integration procedure where an IAB node performs an initial attachment to an upstream or “parent” node” (i.e. another IAB node or a donor node), or when there is an update on the condition of the network link between two IAB nodes or between an IAB node and a donor node.

To perform an initial attachment, the MT part of the IAB node performs the same initial access procedure as a UE, i.e. it makes use of the synchronization signals transmitted by the available cells (formally referred to as “synchronization signal block (SSB)” in NR) to estimate the channel and select the parent. Polese et al., “Integrated Access and Backhaul in 5G mmWave Networks: Potentials and Challenge”, introduces additional information such as the number of hops to reach the donor, the cell load, etc. Then, the IAB node selects the cell to attach to based on more advanced path selection metrics than just the Received Signal Strength (RSS).

Next, the IAB donor establishes one or more backhaul (BH) channels at one or more intermediate IAB nodes/hops towards the newly joining IAB node and updates the routing tables at intermediate hops. The final step establishes BH connectivity between the IAB node and the core network (e.g. 5GC or Evolved Packet Core (EPC)). This means that the F1 protocol can be used to configure the Distributed Unit (DU) function of IAB node and after that, the node can start serving the UE.

Currently available techniques for a IAB donor to establish a route for a new IAB node and maintaining routes in an IAB network are based on information about the condition of the route (for example, using network level key performance indicators (KPIs) such as number of hops, latency, packet loss and jitter, and also hop metrics such as current load which can be expressed as a current number of active subscribers, throughput, or Central Processing Unit (CPU) load). However, the currently available techniques do not take into account the two following factors:
Dynamicity/seasonality of mobile traffic in terms of heterogeneity and throughput patterns. Different IAB nodes may serve UEs that belong to different types of services (for example mission-critical or best effort type of services) and exhibit different throughput patterns (for example sensors may exhibit traffic patterns following a uniform distribution, whereas vehicles travelling through a city may exhibit traffic patterns following a normal distribution, with a mean on rush hour). While mapping to bearers or flows (in 5G) may be a way to address Quality of Service (QOS) in Radio Access Network (RAN) traffic (cf. International patent application WO 2021/019332), by means of being setup by policies specified in Policy Control Function (PCF) (in 5G) or Policy Control and Charging Rules Function (PCRF) (in 4G), currently known approaches typically do not include energy-related objective factors when setting up routes across relay nodes (i.e. IAB nodes).
Energy consumption n is not uniform across all routes. Different gNBs have different power efficiency rating (e.g. watt per kb transmitted or received information), as the base stations are combinations of different models of different vendors receiving, transmitting, and processing mobile data traffic in different frequencies (and all these characteristics affect energy consumption). As gNBs are not static but get upgraded with new components (for instance, additional or new models of radios, baseband, routers, etc.) or software upgrades of these components, their energy consumption profiles change as well.
   Energy-aware routing is examined in Gattulli et al. “Low-carbon routing algorithms for cloud computing services in IP-over-WDM networks” and Restrepo et al. “Energy Profile Aware Routing”. Gattulli et al. and Restrepo et al. propose two algorithms—Sun and Wind Energy Routing (SWEAR) and Green Energy Aware Routing (GEAR). SWEAR works by comparing two candidate paths-one with the lowest transport/power consumption, and the other with the maximum usage of renewable energy. To choose between the two, it is observed whether there is an increase in transport power compensated by renewable energy. GEAR on the other hand directly finds the path with the lowest non-renewable energy consumption (brown power) by assigning as weights of a transport link the transport power, and as weight of the anycast link the current brown power of the Direct Current (DC) traversed by the link. Thereafter, shortest path algorithm is used to obtain the minimum brown power path. Both algorithms assume that information about energy source and energy consumption is provided for each node in the network path.
   In Restrepo et al. “Energy Profile Aware Routing”, Energy Profile Aware Routing (EPAR) is proposed, which considers the energy profile and actual load of each equipment. Thereafter it makes use of constraint-based routing and Multiprotocol Label Switching (MPLS) to generate the most energy efficient path.
   Compared to the techniques proposed in Gattulli et al. and Restrepo et al., embodiments described in the present disclosure propose using Reinforcement Learning (RL) instead of more classic algorithms for network routing. RL in network routing is discussed in You et al. “Toward packet routing with fully-distributed multi-agent deep reinforcement learning” and Jafarzadeh et al. “Design of energy-aware QoS routing algorithm in wireless sensor networks using reinforcement learning”. Unlike Gattulli et al. and Restrepo et al., the techniques discussed in You et al. and Jafarzadeh et al. do not take into consideration the type of energy source used by the elements in the network path.

Embodiments described herein relates to a machine learning component in the routing planning process taking place at an IAB donor. The component is triggered by either onboarding of a new IAB node or by periodical reporting of link status from an existing IAB node to IAB donor. The machine learning component predicts the future state of the network link and affects the IAB donor's decision to configure routing in each IAB node.

The donors and IAB nodes network use an off-policy reinforcement learning approach. Specifically, a donor having a software agent interacts with the environment, i.e. the network of IAB nodes, receiving state updates from those nodes. The donor maintains a neural network which given a state update from the nodes, predicts a future state. A state update contains an IAB node traffic profile description and/or an energy profile description of the node. Using the predicted future state, the donor may reconfigure the routing tables to optimise use of throughput and/or energy use (so-called “green routing”). From the next state update after the node's action, a reward is calculated which indicates whether the agent made a good decision or not.

According to embodiments described herein, the proposed solution can be scaled to multiple agents in a cooperative multi-agent reinforcement learning type of approach. In addition, the proposed solution can be used in isolation or in tandem with existing approaches of current state of the links. According to some embodiments described herein, there is provided a green path selection based on future (predicted) state of use of energy from renewable sources at the IAB nodes. According to some embodiments described herein, there is provided a high-performing path selection based on future (predicted) data traffic generation from UE belonging to IAB nodes.

Certain embodiments of the present disclosure allow best traffic paths to be selected based on the traffic profiles of the IAB nodes present in the network. Certain embodiments allow energy consumption to be reduced by creating “green” data paths (which can be used in tandem with optimisation of radio access) and/or connection to macro sites. According to certain embodiments, path selection may be made based on installed solar photovoltaic cells or other green energy on site, macro sites, or IAB sites within the architecture, where each site can provide a “green index” for the purpose to determining reward in the context of reinforcement learning. Techniques according to the present disclosure may be used in combination with existing network key performance indicators (KPIs) to influence routing decisions at IAB donors.

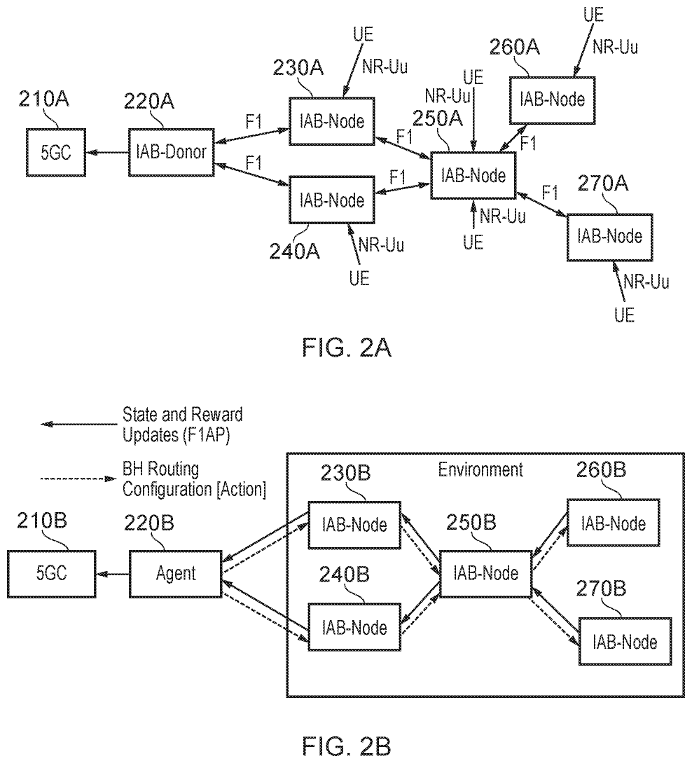

FIG. 2A illustrates an IAB network according to an embodiment of the present disclosure. The IAB network includes including a 5G Core (5GC) network 210A, an IAB donor 220A, a plurality of IAB nodes 230A, 240A, 250A, 260A, and 270A. The F1 interfaces between the IAB donor 220A and IAB nodes are represented by double-headed arrows between the respective entities, and the NR-Uu interfaces between UEs (not shown in the drawing) and respective IAB nodes are represented by single-headed arrows in the diagram.

FIG. 2B illustrates the system of FIG. 2A converted into a reinforcement learning context. In FIG. 2B, the IAB donor is now referred to as an agent 220B, and the plurality of IAB nodes 230B, 240B, 250B, 260B, and 270B are shown as part of an environment. The agent 220B interacts with the environment where, given a state of the environment, the agent 220B takes actions, and observes the reward because of its actions as well as the next state of the environment. Over time, the agent 220B learns to take those actions that result in the greatest immediate and future-discounted reward.

The agent 220B may be implemented as a logical function residing within the IAB donor, or outside of it (e.g. as part of the 5CG network 210B or a local cloud).

As mentioned above, the environment according to the present embodiment includes the plurality of IAB nodes 230B, 240B, 250B, 260B, and 270B, each having an upstream route towards the IAB donor (i.e. the agent 220B in this embodiment), and some having a downstream route towards another IAB node. In addition, the IAB nodes have termination points, connecting their attached UEs to the 5G Core network 210B.

The agent 220B may receive state updates from the IAB nodes via F1-AP route status updates (as represented by the solid arrows in FIG. 2B), and take actions by sending routing configuration messages to the IAB nodes (as represented by the dotted arrows in FIG. 2B).

In the context of reinforcement learning, the state space according to the present embodiment may comprise the following information:
Routing table for packets to all IAB nodes
Energy index table which includes information of the energy efficiency of each IAB node
Traffic profile of each IAB node.

The state space may be composed at the agent 220B after updates are received with respect to the constituents of the state space as described above from all the plurality of IAB nodes. In this embodiment, the information communication between the IAB nodes and the agent 220B regarding state updates may be limited to updated information from a previous state.

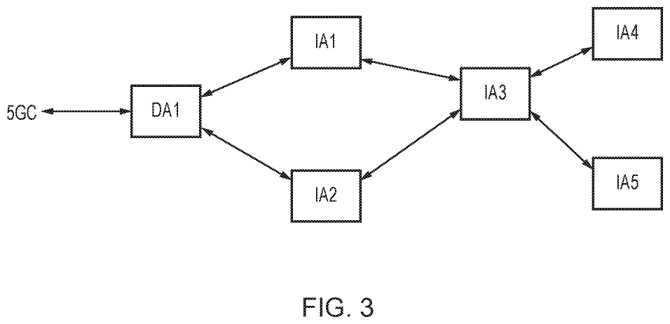

FIG. 3 is diagram illustrating exemplary topology of IAB nodes and IAB donor, according to an embodiment of the present disclosure. In this embodiment, the exemplary topology is similar to the arrangements shown in FIGS. 2A and 2B in that the illustrated network includes a 5GC network, an IAB donor DA1, a first IAB node IA1, a second IAB node IA2, a third IAB node IA3, a fourth IAB node IA4, and a fifth IAB node IA5.

In the present embodiment, each IAB node maintains a routing table which routes messages of F1 protocol from an original node to a destination node. DA1 may contain information with regard to the routing at all IAB nodes in the topology. For example, the following routing table may be stored in the memory of the first IAB node IA1:

TABLE 1
An exemplary routing table at an IAB donor
Routing Table

| Node | | | |
|---|---|---|---|
| Name | Rule Filter | Direction | Next Node |
| DA1 | From: * To: UE.IA3, | Downstream (i.e. from | IA1 |
| | UE.IA4, UE.IA5 Type: | the IAB donor DA1) | |
| | UDP | | |
| DA1 | From * To: UE.IA1, | Downstream | IA1 |
| | Type: * | | |
| DA1 | From: * To: UE.IA3, | Downstream | IA2 |
| | UE.IA4, UE.IA5 Type: | | |
| | TCP | | |
| DA1 | From: * To: UE.IA2 | Downstream | IA2 |
| | Type: * | | |
| DA1 | From: UE.IA1 To * | Upstream (i.e. towards | 5GC |
| | Type * | the IAB donor DA1) | |
| DA1 | From: UE.IA2 To * | Upstream | 5GC |
| | Type * | | |
| IA3 | From: UE.IA3, UE.IA4, | Upstream | IA1 |
| | UE.IA5 To * Type: | | |
| | UDP | | |
| IA3 | From: UE.IA3, UE.IA4, | Upstream | IA2 |
| | UE.IA5 To * Type: | | |
| | TCP | | |
| IA3 | From: * To UE.IA3 | Downstream | Forward to UE over |
| | Type: * | | NR-Uu interface |
| IA3 | From: * To IA4, IA5 | Downstream | Forward to UE over |
| | Type: * | | NR-Uu interface |

[More rules for IA1, IA2, IA4, IA5 may be included in this routing table]

According to the routing table as shown above, traffic flows with User Datagram Protocol (UDP) traffic generally get routed through the DA1-IA1-IA3-(IA4/IA5) route, and traffic flows with Transmission Control Protocol (TCP) generally get routed through DA1-IA2-IA3-(IA4/IA5). Also, all traffic generated from or flowing to IA2 has to be routed through DA1-IA2 traffic path regardless of whether it is TCP or UDP. The rule filters included in Table 1 are for exemplary purposes and it will be appreciated that in other embodiments may not filter only with respect to transport protocol, but also (or alternatively) with respect to other protocol layers, source, and/or destination.

An example of a packet filter is the 3GPP Service Data Flow, which filters on Internet Protocol (IP), transport layer and application headers. The direction column in Table 1 indicates whether the traffic flow is towards the 5G Core Network (northbound) or towards a UE-destination in the Radio Access Network (RAN) (southbound). The UE.IAx in Table 1 indicates a destination or origin UE attached to the IAB node IAx. The size of the state space may depend on the number of nodes in the network and their interconnections, as well as the type of rule filters which parameterise these interconnections.

In addition, every IAB node may store its own routing table that it executes upon reception of a data packet. In the present embodiment, for example, IA3 would maintain a routing table consisting of the last four rows in Table 1.

The energy index table as mentioned above with reference to FIG. 2B relates to the energy performance of each IAB node. The energy index table may be stored at the IAB donor and updated periodically by IAB nodes. An example of an energy index table is provided below:

TABLE 2
An exemplary energy index table at an IAB donor
Energy Index Table at IAB donor

| Node | Performance Per Watt (PPW) |
|---|---|
| IAB1 | List <PPWValueIAB1, CleanEnergySourcePercentageIAB1, |
| | timestamp> |
| IAB2 | List <PPWValueIAB2, CleanEnergySourcePercentageIAB2, |
| | timestamp> |
| IAB3 | List <PPWValueIAB3, CleanEnergySourcePercentageIAB3, |
| | timestamp> |

[The table may include more rows]

To indicate the power efficiency of an IAB node, a performance per watt metric (“PPWValueIABx”) may be used in some embodiments. More specifically, this metric could be W/Kbps (an amount of watts spent per kilobit of data transmitted per second, capturing the spectral efficiency of the transmitted data bits), indicating how much power is spent by an IAB node (as a whole rather than by individual components, for example radios or baseband board or switches).

The energy index table may maintain a historical list of values at least up to a point in the past. This can be implemented using cyclic buffers, wherein older values are discarded for newer ones. In some embodiments, the energy index table may also include energy source values (“CleanEnergySourcePercentageIABx”) each indicating a respective percentage of power from the base station produced by a renewable energy source (e.g. a solar panel or a wind turbine). For example, at the time of measurement (indicated by the “timestamp” in the table) it could be that 20% of the power was produced by photovoltaic (PV) cells, and 80% from a coal energy source (e.g. supplied from the power grid).

Although not shown in Table 2, in some embodiments the energy index table may include a carbon emissions value (e.g. carbon emissions per watt-hour represented in kg CO₂/Kwh) instead of an “energy source value” (which indicates a percentage of power produced by renewable energy source(s)). A lower carbon emissions value may indicate the power is “cleaner”, while a higher carbon emissions value may indicate that the power is “dirtier”, i.e. from unsustainable energy sources (e.g. fossil fuel based).

The traffic profile as mentioned above with reference to FIG. 2B may be defined by characterising data traffic generated from a specific UE. In some embodiments, this characterisation may include, for a respective IAB node, historical data records (e.g. a list of uplink/downlink throughput over a sampled period). In some embodiments, this characterisation may include, for a respective IAB node, a data probability distribution that is parameterised by type (e.g. normal, uniform, etc.) and a set of parameters for the distribution type, for example μ, σ for normal distribution. The distribution may cover a repeating traffic pattern for UEs attached to the respective IAB node, e.g. data traffic generated over the course of a day (24 hours).

An action in the context of the present disclosure defines the modification of one or more routing rules (e.g. one or more columns of Table 1) for a given IAB node. In some embodiments, the agent may update its own routing table and then request IAB node(s) to update their own routing table(s) by forwarding a backhaul (BH) routing configuration message. If the request message representing the modification is larger than a threshold allowed at an IAB node, then multiple messages may be sent from the agent to affect the respective IAB node(s) as part of the execution of the action. The size of the action space may depend on the type of modifications that can be made in the packet filer, as well as the number of IAB nodes.

According to some embodiments, actions available to the reinforcement learning system may include two basic actions: adding an entry to the routing table and removing an entry from the routing table. The two actions are the minimum required for operation in some embodiments, with further optimisation possibilities through the introduction of additional actions, e.g. modifying an entry as a combination of the two basic actions.

The (discrete) action space A may be defined as

$$A = \{ ( a , p ) \vert a ∈ \{ add , remove \} , p ∈ {P}_{a} \}$$

where a is an add or move action, and Pₐ is a set of action parameters, consisting of tuples:

$${P}_{a} ⊆ DestinationPrefix \times GWaddress \times HardwareAddress$$

where the action parameters denote the standard routing table entry with the destination denoted by the IP address prefix, gateway IP address and the hardware address of the interface to use.

When adding an entry, an IP address prefix may be used to indicate which packets to route (using a destination filter), and an IP address may be used to indicate where (a gateway or a device) to route the packets. The device may be an available router (M), and the IP address may refer to the available address which have been assigned to the IAB nodes (K). In both cases the options are finite. In some embodiments, an action may adopt the following format:
type [add/remove] (IP_address_prefix, gateway (IP/mac address), destination)

An example action could be:
(add, (198.51.100.0/24, 192.0.2.1, 02:00:00:00:00))

Extensions to the actions may be possible by adding parameters, for example to match the network protocol of the flow, etc.

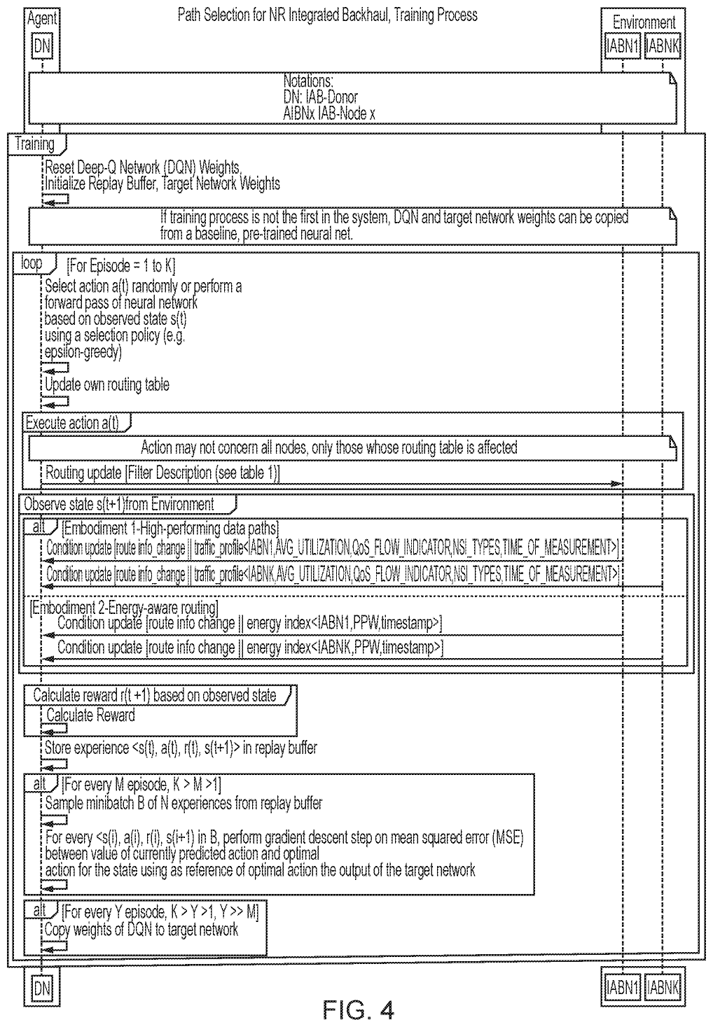

FIG. 4 is a sequence diagram illustrating an exemplary training process of NR integrated backhaul, according to an embodiment of the present disclosure.

According to some embodiments, the path selection problem is framed as a reinforcement learning problem, and in particular use of the mathematical framing of a Markov decision process with unknown transition function (state, action, reward). Given the potentially complexity of the decision and action space, an embodiment may involve the use of a deep neural network to allow the agent to select the optimal action (route configuration) for a state. FIG. 4 illustrates a double deep-q network learning algorithm (DDQN)—in addition to a deep-q network (DQN), the algorithm considers a separate network (referred to as a “target network), which is updated periodically from the weights of the DQN during the training process.

The training process illustrated in FIG. 4 is performed by means of gradient descent, which is a popular training algorithm for deep neural networks.

As in the case with the target network update, training of the DQN is also performed periodically, but not necessarily in every iteration. The measure of how “good” an action selection is given by a reward function, which is calculated after the agent (IAB node) observes the IAB nodes for “condition updates” which are delivered via the F1AP interfaces.

The reward and the condition updates may depend on the type of optimisation objective. In the case of optimisation of traffic flow to use high-performing data paths, the calculation may be based on the traffic profile of each IAB node. A traffic profile may be parameterised as follows (this information may be carried within a condition update):
[Source], [Average Utilization avgᵤₜᵢl], [QOS Flow Indicator], [NSI Types], [Time of measurement]

The parameters Quality of Service (QOS) flow Indicator and Network Slice Instance (NSI) Types may be optional in some embodiments. More specifically, in some embodiments either one of QoS flow indicator and NSI types may be used, for example depending on whether the traffic is in a 4G network or a 5G network. For example, in case of a 4G network:
[IAB-Node 2], [100], [0.22], [QCI=5, 3, 1], [2020-1-1 10:10. 2020-2-1 10:10]

The example above indicates that the traffic at IAB-Node 2 is utilizing 22% of node capacity, belonging to prioritised classes of Quality Class Identifiers 5, 3, and 1 being sampled during one month from 1st of January to 1st of February 2020.

A 5G example is provided below, where the traffic profile of an IAB node is characterised by the type of service used by the UE(s) attached at a respective IAB node. For example, assuming the International Telecommunication Union's (ITU's) 3 service types: enhanced mobile broadband (eMBB), mission critical machine type communication (mMTC), and ultra-reliable low latency communication (uRLLC):
[IAB-Node 2], [0.22], [ITU_SERV_TYPE=uRLLC, mMTC], [2020-1-1 10:10. 2020-2-1 10:10]

The reward may be calculated at the end of the respective observation period as follows:
Establish existing routing paths from information in the routing table
For every routing path k in m routing path:
   For every node i of nodes q in the path, calculate path_reward_{nodei}=(1−avgᵤₜᵢₗ)/w_{service_type}, wherein:
      w_{service_type}=1 if ITU_SERV_TYPE=urLLC ∥ ITU_SERV_TYPE=mMTC ∥ QCI!=9
      else w_{service_type}=0.5
      Note: In the above calculation, avgᵤₜᵢ is an average for all condition updates supplied by node n for the period and w_{service_type} appends all service types from all condition updates
   Calculate path_rewardᵢ=(path_reward_{node1}+ . . . +path_reward_{nodeq})/q
Calculate reward=(path_reward₁+ . . . path_rewardₘ)/m

In the case of optimisation of traffic flow to use green energy paths, the calculation may be based on condition updates relating to energy performance of the IAB nodes and/or the percentage of energy use from clean energy sources (e.g. PV or wind). The condition update may be characterised as follows:
[source], [ren_energy], [ppw], [Time of measurement]

As an example, [IAB-Node2], [0.2], [2.3] [2020-1-1 10:10. 2020-2-1 10:10] means that IAB-Node2 produces an average 20% of its power from renewable sources (ren_energy) and has an average of 2.3 Kw/Kbps PPW for a time of measurement from 2020 Jan. 1 10:10. 2020 Feb. 1 10:10.

In this case, the reward may be calculated at the end of observation period as follows:
Establish existing routing paths from information in the routing table
For every routing path k in m routing paths
   For every node i of nodes q in the path, calculate path_reward_{nodei}=ren_energy*ppw
   Calculate path_rewardᵢ=(path_reward_{node1}+ . . . +path_reward_{nodeq})/q
Calculate reward=(path_reward₁+ . . . path_rewardₘ)/m

In some embodiments, both the performance as well as the “greenness” of existing routing paths can be taken into account. In these embodiments the technique may involve taking an averaged sum of the two aforementioned rewards.

Initially, the algorithm may select actions at random, and gradually replaces random selection with execution of the DQN (also known as a forward pass, in the most common case of a DQN being a multi-layer perceptron), as the agent becomes better at identifying good actions for a state by means of training. A typical selection policy may be the so-called epsilon-greedy policy, wherein epsilon is annealed from 1 towards 0 as training progresses—the agent selects a random action with probability epsilon and an action from an execution of its DQN using a probability 1−epsilon.

In some embodiments, the training process may be run initially during system bootstrapping and repeated from time to time (e.g. periodically or on triggered by an external event), for example when new IAB node(s) are added and/or removed and/or upgraded from the network which could indicate a possible route and/or node power footprint change). In the case of system bootstrapping, the network may reset its deep-q network (DQN) to start learning from the beginning, whereas in the in the case of repeat training, the agent may start by using its old weights as reference. This is a way to transfer experience from previous iterations.

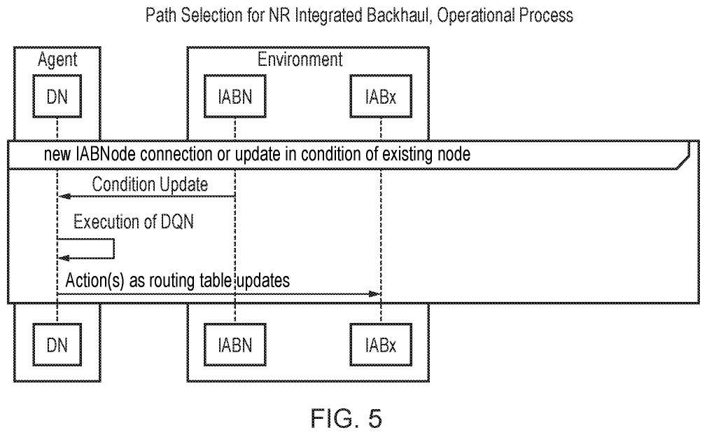

FIG. 5 is a sequence diagram illustrating message flow in a reinforcement learning system during execution, according to an embodiment of the present disclosure. The process may be triggered by the following two cases:
1) Where a new IAB node connects to the network which forces the IAB donor to create a new routing towards 5GC from the newly connected IAB node.
2) Where the agent (or the IAB donor) receives a state update (via F1-AP) from an IAB node, forcing it to consider updating the routing tables.

In a first step as shown in FIG. 5, a condition update Is issued by any of the existing IAB nodes towards the IAB donor (DN). Then, in a second step, execution of the trained DQN (i.e. a forward pass) is performed, which suggests routing updates. Then, at a third step, these routing updates are saved at the IAB donor and are sent for enforcement in the local routing tables of the affected IAB nodes.

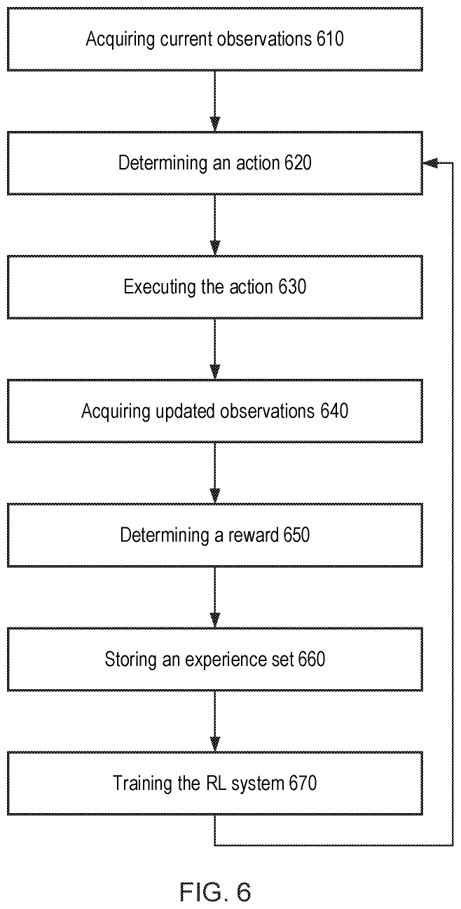

FIG. 6 is a flowchart illustrating a method for training a reinforcement learning system for optimising routing for a network, according to an embodiment of the present disclosure. The reinforcement learning system may apply a deep Q-network or an actor-critic algorithm. The network comprises a plurality of IAB nodes connected to a IAB donor. The method may be performed at the IAB donor, or at a core network, or at a local cloud. More specifically, the illustrated method can generally be performed by or under the control of either or both of a processing circuitry and an interface circuitry, such as processing circuitry and interface circuitry at the IAB node or at a core network. In some embodiments there may be provided a IAB donor configured to perform the method illustrated in FIG. 6.

The method begins at step 610 at which observations characterising a current state of the plurality of IAB nodes are acquired. The observations comprise: routing information for routing packets in the network, energy information indicative of an energy performance of each of the plurality of IAB nodes, and traffic information indicative of data traffic performance of each of the plurality of IAB nodes.

In some embodiments, the routing information may comprise a routing table, and the routing table may comprise a plurality of route entries each associated with a route, each route being characterised by a IAB node to perform routing according to the route, a rule filter, a route direction, and a next node in the route.

In some embodiments, the energy information may comprise an energy index table, the energy index table comprising a historical list of energy entries for each of the plurality of IAB nodes. Each energy index entry may include a timestamp and at least one of an energy efficiency value, a clean energy source percentage, and a carbon emissions value.

In some embodiments, the traffic information may comprise a list of uplink and downlink throughput over a sampled period for each of the plurality of IAB nodes, or a data probability distribution type and a set of parameters for the data probability distribution type for each of the plurality of IAB nodes, the data probability distribution type and the set of parameters characterising data traffic at a respective IAB node over a predetermined time period.

Returning to FIG. 6, the method then proceeds to step 620 at which an action to be performed is determined from a predetermined set of actions, using a selection policy (e.g. an epsilon-greedy policy or a softmax policy), and based on latest acquired observations. The predetermined set of actions include adding an entry to the routing information and removing an entry to the routing information, an entry being indicative of how packets are to be routed with respect to a IAB node. In these embodiments, an action is characterised by an action space, the action space including an operation (e.g. “add” or “remove”) and a set of route parameters, the set of route parameters including a type of packet to route, a destination of the respective route, and an interface to use for the respective route.

Subsequently, at step 630, the action determined at step 620 is executed, by initiating update of the routing information based on the determined action.

At step 640, observations characterising an updated state of the plurality of IAB nodes are acquired subsequent to execution of the action at step 640. In some embodiments, the observations characterising the updated state of the plurality of IAB nodes may comprise only updated information with respect to a previous state.

Then, at step 650, a reward for the determined action is determined based on the updated state of the plurality of IAB nodes.

As will be described in more detail below with reference to step 670, the reinforcement learning system is to be trained with respect to an optimisation objective, and in some embodiments the optimisation objective may comprise optimising routing of packets in the plurality of IAB nodes to use high-performing data paths. In these embodiments, determining a reward for the determined action at step 650 may comprise: acquiring an average throughput utilisation value for each of the plurality of IAB nodes in the updated state in a sample time period, establish a set of current routing paths based on the acquired observations characterising the updated state of the plurality of IAB nodes subsequent to execution of the action at step 630, calculating a path reward value for each routing path in the set of current routing paths based on the average throughput utilisation values for IAB nodes in a respective routing path, and calculating a total reward value associated with the determined action, wherein the total reward value is the average of all path reward values of the routing paths in the established set of current routing paths.

As will be described in more detail below with reference to step 670, the reinforcement learning system is to be trained with respect to an optimisation object, and in some embodiments the optimisation objective may comprise optimising routing of packets in the plurality of IAB nodes to use green energy data paths. In these embodiments, determining a reward for the determined action at step 650 may comprise: acquiring, for each of the plurality of IAB nodes, at least one of: an energy efficiency value, a clean energy source percentage, and a carbon emissions value, establish a set of current routing paths based on the acquired observations characterising the updated state of the plurality of IAB nodes subsequent to execution of the action at step 630, calculating a path reward value for each routing path in the set of current routing paths based on the at least one of the performance per watt value and the percentage of energy use of IAB nodes in a respective routing path, and calculating a total reward value associated with the determined action, wherein the total reward value is the average of all path reward values of the routing paths in the established set of current routing paths.

At step 660, an experience set is stored, the experience set including the (latest) determined action, the (latest) observations characterising the state of the plurality of IAB nodes prior to execution of the determined action, the observations characterising the state of the plurality of IAB nodes subsequent to execution of the (latest) determined action, and the (latest) determined reward.

The method then proceeds to step 670 at which the reinforcement learning system is trained to maximise reward with respect to an optimisation objective, the training using the one or more stored experience sets in the buffer. The optimisation objective may comprise at least one of: optimising routing of packets in the plurality of IAB nodes to use high-performing data paths, and optimising routing of packets in the plurality of IAB nodes to use green energy data paths.

As shown in the flowchart, steps 620 to 670 are performed iteratively, and the iteration terminates until a termination condition is met. For example, the termination condition may be that the reward associated with the latest determined action being lower or equal in value to the reward associated with the determined action in the previous iteration, or that the value of the reward associated with the latest determined action exceeding a predetermined threshold.

It will be appreciated that although the steps in the method illustrated in FIG. 6 have been described as being performed sequentially, in some embodiments at least some of the steps in the illustrated method may be performed in a different order, and/or at least some of the steps in the illustrated method may be performed simultaneously.

It will be appreciated although the above description is provided with respect to a single IAB donor, the method illustrated in FIG. 6 may be applied in an architecture which includes multiple IAB donors having multiple physical connections to the 5GC. In embodiments where the method involves multiple IAB donors, a cooperative multi-agent approach may be used where each IAB donor has partial observability on the routes it is managing. The reward determination may be performed in a similar manner as described above, and shared among the different IAB donors. The IAB donors may also share experience sets to enhance learning speed.

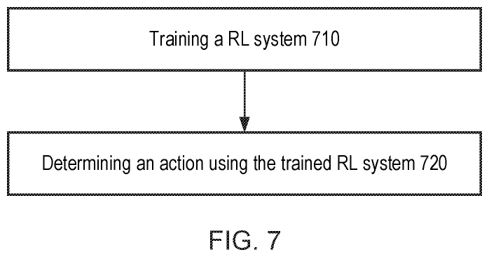

FIG. 7 is a flowchart illustrating a method for managing routing for a network, according to an embodiment of the present disclosure. The network includes a plurality of IAB nodes connected to a IAB donor. The method may be performed at the IAB donor, or at a core network, or at a local cloud. More specifically, the illustrated method can generally be performed by or under the control of either or both of a processing circuitry and an interface circuitry, such as processing circuitry and interface circuitry at the IAB node or at a core network. In some embodiments there may be provided a IAB donor configured to perform the method illustrated in FIG. 7.

The method begins at step 710 at which a reinforcement learning system is trained. The training may be performed according to the method as illustrated in FIG. 6 and described with reference to FIG. 6 above.

Subsequently, at step 720, the trained reinforcement learning system is used to determine an action for a IAB node in the plurality of IAB nodes upon a condition trigger. The condition trigger may be that one of the plurality of IAB nodes receives a hardware or software update or an expiry of a predetermined periodic timer.

Any appropriate steps, methods, or functions may be performed through a computer program comprising instructions which, when executed by processing circuitry, cause the processing circuitry to perform the steps, methods, or functions. Furthermore, any appropriate steps, methods, or functions may be performed through a computer program product that may, for example, be executed by the components and equipment described herein. For example, there may be provided a storage or a memory at the IAB donor that may comprise non-transitory computer readable means on which a computer program can be stored. The computer program may include instructions which cause processing circuitry (and optionally interface circuitry, and optionally any operatively coupled entities and devices) to execute methods according to embodiments described herein. The computer program and/or computer program product may thus provide means for performing any steps herein disclosed.

Embodiments of the disclosure thus introduce methods and apparatuses for training a reinforcement learning system for optimising routing for a network and for managing routing for a network.

The above disclosure sets forth specific details, such as particular embodiments or examples for purposes of explanation and not limitation. It will be appreciated by one skilled in the art that other examples may be employed apart from these specific details.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for training a reinforcement learning system for optimising routing for a network including a plurality of Integrated Access and Backhaul (IAB) nodes connected to an IAB donor, the method comprising:
acquiring observations characterising a current state of the plurality of IAB nodes, wherein the observations comprise: routing information for routing packets in the network, energy information indicative of an energy performance of each of the plurality of IAB nodes, and traffic information indicative of data traffic performance of each of the plurality of IAB nodes; and
performing the following steps iteratively until a termination condition is met:
determining an action to be performed from a predetermined set of actions using a selection policy and based on latest acquired observations, wherein the predetermined set of actions include adding an entry to the routing information and removing an entry to the routing information, wherein an entry is indicative of how packets are to be routed with respect to an IAB node of the plurality of IAB nodes;
executing the action by initiating update of the routing information based on the determined action;
acquiring observations characterising an updated state of the plurality of IAB nodes subsequent to execution of the action;
determining a reward for the determined action, based on the updated state of the plurality of IAB nodes;
storing an experience set including the determined action, the observations characterising the state of the plurality of IAB nodes prior to execution of the determined action, the observations characterising the state of the plurality of IAB nodes subsequent to execution of the determined action, and the determined reward; and
training the reinforcement learning system to maximise reward with respect to an optimisation objective, using the one or more stored experience sets in the buffer.

2. The method according to claim 1, wherein the termination condition is one of:
the reward associated with the latest determined action being lower or equal in value to the reward associated with the determined action in the previous iteration, and
the value of the reward associated with the latest determined action exceeding a predetermined threshold.

3. The method according to claim 1, wherein the optimisation objective comprises at least one of: optimising routing of packets in the plurality of IAB nodes to use high-performing data paths and optimising routing of packets in the plurality of IAB nodes to use green energy data paths.

4. The method according to claim 3, wherein the optimisation objective comprises optimising routing of packets in the plurality of IAB nodes to use high-performing data paths, and wherein determining a reward for the determined action comprises:
acquiring an average throughput utilisation value for each of the plurality of IAB nodes in the updated state in a sample time period;
establish a set of current routing paths based on the acquired observations characterising the updated state of the plurality of IAB nodes subsequent to execution of the action;
calculating a path reward value for each routing path in the set of current routing paths based on the average throughput utilisation values for IAB nodes in a respective routing path; and
calculating a total reward value associated with the determined action, wherein the total reward value is the average of all path reward values of the routing paths in the established set of current routing paths.

5. The method according to claim 3, wherein the optimisation objective comprises optimising routing of packets in the plurality of IAB nodes to use green energy data paths, and wherein determining a reward for the determined action comprises:
acquiring, for each of the plurality of IAB nodes, at least one of: an energy efficiency value, a clean energy source percentage, and a carbon emissions value;
establish a set of current routing paths based on the acquired observations characterising the updated state of the plurality of IAB nodes subsequent to execution of the action;
calculating a path reward value for each routing path in the set of current routing paths based on the at least one of the performance per watt value and the percentage of energy use of IAB nodes in a respective routing path; and
calculating a total reward value associated with the determined action, wherein the total reward value is the average of all path reward values of the routing paths in the established set of current routing paths.

6. The method according to claim 1, wherein an action is characterised by an action space, wherein the action space includes an operation and a set of route parameters, and wherein the set of route parameters include a type of packet to route, a destination of the respective route, and an interface to use for the respective route.

7. The method according to claim 1, wherein the routing information comprises a routing table, wherein the routing table comprises a plurality of route entries each associated with a route, and wherein each route is characterised by a IAB node to perform routing according to the route, a rule filter, a route direction, and a next node in the route.

8. The method according to claim 1, wherein the energy information comprises an energy index table, wherein the energy index table comprises a historical list of energy entries for each of the plurality of IAB nodes, and wherein each energy index entry includes a timestamp and at least one of an energy efficiency value, a clean energy source percentage, and a carbon emissions value.

9. The method according to claim 1, wherein the traffic information comprises one of:
a list of uplink and downlink throughput over a sampled period for each of the plurality of IAB nodes; and
a data probability distribution type and a set of parameters for the data probability distribution type for each of the plurality of IAB nodes, wherein the data probability distribution type and the set of parameters characterise data traffic at a respective IAB node over a predetermined time period.

10. The method according to claim 1, wherein the observations characterising the updated state of the plurality of IAB nodes comprises only updated information with respect to a previous state.

11. The method according to claim 1, wherein the selection policy is one of an epsilon-greedy policy and a softmax policy.

12. The method according to claim 1, wherein the reinforcement learning system applies a deep Q-network or an actor-critic algorithm.

13. The method according to claim 1, wherein the method is performed at the IAB donor, or at a core network, or at a local cloud.

14. A The method according to claim 1, further comprising:
using the trained reinforcement learning system to determine an action for the IAB node upon a condition trigger.

15. The method according to claim 14, wherein the condition trigger is one of:
a new IAB node connecting to the network, wherein the new IAB node forms part of the plurality of IAB nodes;
one of the plurality of IAB nodes receiving a hardware or software update; and
an expiry of a predetermined periodic timer.

16. (canceled)

17. A non-transitory computer-readable medium having stored thereon computer-executable, instructions that, when executed by a processing circuitry, cause the processing circuitry to execute operations, the operations comprising:
acquiring observations characterising a current state of the plurality of IAB nodes, wherein the observations comprise: routing information for routing packets in the network, energy information indicative of an energy performance of each of the plurality of IAB nodes, and traffic information indicative of data traffic performance of each of the plurality of IAB nodes; and
performing the following steps iteratively until a termination condition is met:
determining an action to be performed from a predetermined set of actions using a selection policy and based on latest acquired observations, wherein the predetermined set of actions include adding an entry to the routing information and removing an entry to the routing information, wherein an entry is indicative of how packets are to be routed with respect to an IAB node of the plurality of IAB nodes;
executing the action by initiating update of the routing information based on the determined action;
acquiring observations characterising an updated state of the plurality of IAB nodes subsequent to execution of the action;
determining a reward for the determined action, based on the updated state of the plurality of IAB nodes;
storing an experience set including the determined action, the observations characterising the state of the plurality of IAB nodes prior to execution of the determined action, the observations characterising the state of the plurality of IAB nodes subsequent to execution of the determined action, and the determined reward; and
training the reinforcement learning system to maximise reward with respect to an optimisation objective, using the one or more stored experience sets in the buffer.

18. An Integrated Access and Backhaul (IAB) donor node configured to:
acquire observations characterising a current state of the plurality of IAB nodes, wherein the observations comprise: routing information for routing packets in the network, energy information indicative of an energy performance of each of the plurality of IAB nodes, and traffic information indicative of data traffic performance of each of the plurality of IAB nodes; and
perform the following steps iteratively until a termination condition is met:
determine an action to be performed from a predetermined set of actions using a selection policy and based on latest acquired observations, wherein the predetermined set of actions include adding an entry to the routing information and removing an entry to the routing information, wherein an entry is indicative of how packets are to be routed with respect to an IAB node of the plurality of IAB nodes;
execute the action by initiating update of the routing information based on the determined action;
acquire observations characterising an updated state of the plurality of IAB nodes subsequent to execution of the action;
determine a reward for the determined action, based on the updated state of the plurality of IAB nodes;
store an experience set including the determined action, the observations characterising the state of the plurality of IAB nodes prior to execution of the determined action, the observations characterising the state of the plurality of IAB nodes subsequent to execution of the determined action, and the determined reward; and
train the reinforcement learning system to maximise reward with respect to an optimisation objective, using the one or more stored experience sets in the buffer.
